(19) United States
(12) Patent Application Publication
(10) Pub. No.: US 2006/0030349 A1
(43) Pub. Date: Feb. 9, 2006

(54) Emergency calling system for a passenger transporting system, especially for a motor vehicle and a method for automatically transmitting an emergency call

(75) Inventors: Thomas Fabian, Hildesheim (DE); Stefan Kollmorgen, Gifhorn (DE); Jorg Plumeier, Braunschweig (DE)

Correspondence Address: NORRIS, MCLAUGHLIN & MARCUS, P.A., 875 THIRD AVE, 18TH FLOOR, NEW YORK, NY, 10022, US

(73) Assignee: VOLKSWAGEN Aktiengesellschaft, Wolfsburg (DE)

(21) Appl. No.: 11/184,260

(22) Filed: Jul. 19, 2005

(30) Foreign Application Priority Data
Jul. 21, 2004 (DE) 10 2004 035 988.1

(51) Int. Cl. H04M 3/22; H04M 11/04; H04Q 7/20; H04B 7/00

(52) U.S. Cl. 455/521; 379/45; 381/57; 381/86; 379/35

(57) ABSTRACT

Invention relates to an emergency calling system for a passenger transporting system, especially for a motor vehicle, with a transmitter for establishing a telephonic connection with an external receiving station, such as a call center (18) or the like, as well as to a method for automatically transmitting an emergency call from a passenger transporting system, especially from a motor vehicle. At least one reproduction parameter of the audio output is set to a predefined value when the telephonic connection is established. The invention furthermore relates to an audio reproducing device for a passenger transporting system, especially for a motor vehicle.

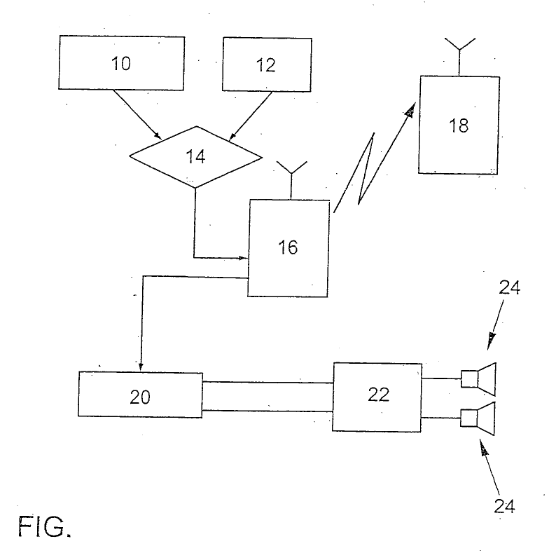

The invention relates to an emergency calling system for a passenger transporting system, especially for a motor vehicle, of the introductory portion of claim 1 and to a method for automatically transmitting an emergency call from a passenger transporting system, especially from a motor vehicle, of the introductory portion of claim 9.

Emergency calling systems, especially in motor vehicles, are known from the state of the art. For these, the connection to an external receiving station is built up either when a vehicle occupant actuates an emergency calling key or the like or if sensors, installed in the vehicle, detect either a critical driving situation or an accident, which has already occurred. Such a call may be a simple emergency call message to a central rescue office or also establish a telephonic connection with a call center.

From the DE 199 22 730 A1, an emergency calling system of a motor vehicle is known, in which an emergency call to an external receiving station is transmitted when a particular limiting value for the degree of probability of a pending accident is exceeded. The probability is ascertained in this connection by measuring means, such as a radar system, which measures the relative speed and the distance of the vehicle from a different vehicle or an obstacle. If further sensors, which are mounted in the vehicle and which can detect a collision, do not emit a suitable signal within a specified time period, the emergency call is retracted.

A similar emergency device is known from DE 199 17 207 C2. For this, an emergency call message is sent out to a central rescue office when sensors ascertain a critical driving situation even before there has been an actual accident. A second message is sent out after a particular period of time, in which either the first message is declared to be invalid when there has been no accident or, in the other case, further information for rescue measures is transmitted.

In addition, various techniques for regulating the loudness of audio reproducing equipment in a vehicle are known. Since various background sound effects, such as engine noises and wind noises, add up while a vehicle is being driven, it is necessary to make certain that acoustic signals, originating from the radio of a motor vehicle or from a mobile telephone device, continue to be sufficiently perceptible. The DE 100 52 104 A1 discloses a method, in which the loudness of different acoustic sources is ascertained separately and these various components are evaluated on the basis of a sample comparison. The loudness of the different acoustic components can be adjusted on the basis of this calculation. This has the advantage that not only the total loudness of the background noise is determined. By these means, it becomes possible to adapt the loudness differently for the respective driving situation.

The DE 198 09 522 A1 discloses a device, in which the loudness, which is present at the end of an automatically superimposed traffic announcement, is scanned, so that the same loudness can be set at the device during a later, renewed, automatic superimposition of a traffic announcement. This loudness is independent of the changes in loudness, made in the meantime by the occupants of the vehicle. By these means, it is achieved that the traffic radio message can be understood clearly and distinctly, even if the user has lowered the volume of the radio between the announcements, in order, for example, to hear soft classical music in the background.

The DE 195 33 260 A1 describes a method for controlling the dynamics of low-frequency signals especially for the hands-free operation and for making a phone call with a handset in a motor vehicle. When the acoustic signals of low amplitude are covered by an increasing basic noise level, which typically develops as the speed of a vehicle increases, the occupant of a vehicle has greater difficulty with interpreting the informational content of audio outputs. This difficulty is avoided owing to the fact that the dynamic region of the low-frequency signals is reduced at greater loudness. By these means, the acoustic signals of low amplitude continue to be understood and the maximum amplitude of the acoustic signal need not be increased to such an extent, that it aggravates the user.

It is a disadvantage of the known emergency calling devices in vehicles that, when a telephone connection is established between the occupant of a vehicle and an external receiving station in the event of an emergency call, the parameters of the audio output of the mobile telephone generally remain unchanged, namely at the values last determined by the occupant of the vehicle. If, shortly before the onset of a critical driving situation, the occupant of the vehicle was listening, for example, to soft classical music, the volume of the audio reproduction over the telephone would also be turned down. When an accident actually occurs, it would be very impracticable for the occupant of a vehicle to actualize the loudness or other parameters of the audio reproduction. Since a differentiation between an emergency call, speech operation and normal telephone conversations cannot be made with the previously known state of the art, the loudness must be adjusted manually at the radio system by the occupant of a vehicle even in the event of an emergency.

It is an object of the invention to indicate an emergency calling device, for which cumbersome corrections of the reproduction parameters do not have to be made.

Pursuant to the invention, this objective is accomplished by means of an emergency calling system for a passenger transporting system, especially for a motor vehicle, with the distinguishing features named in claim 1 or by means of a method for automatically transmitting an emergency call from a passenger transporting system, especially from a motor vehicle, with the distinguishing features named in claim 9.

Owing to the fact that at least one reproduction parameter of the audio output is set at a predefined value after the telephonic connection has been established, it is advantageously achieved that, in a critical situation, in which the occupant of a vehicle is in a position, only with great difficulty if at all, to adapt various acoustic reproduction parameters manually, for example, at the radio system, the occupant is not forced to make such a correction. Typically, the emergency calling system includes a mobile telephone device and a radio or radio navigation system.

In a preferred embodiment of the invention, the telephonic connection can be established in that an occupant of the vehicle or by a sensor, which detects a critical situation or an accident that has already occurred, activates an emergency calling key or the like. In the latter case, the connection is established automatically, whereas, in the former case, it is established with simple means.

It is furthermore preferred that the loudness of the audio output can be increased but not decreased manually with respect to the minimum value set. Accordingly, the occupant of the vehicle has the possibility of making a correction, it being guaranteed that the communication between him and the call center does not become worse. Such a measure is taken for safety reasons

It is particularly preferred that, after the telephonic connection is established, the loudness of the audio output is set to a minimum value. By these means, it is achieved that the occupant of the vehicle can clearly and distinctly hear instructions or information from a calling agent right from the very start of a conversation.

It is particularly preferred that the emergency calling system has means for calculating the minimum value of the loudness, which is to be set as a function of the noise level. This can be accomplished, for example, by comparing the loudness of different acoustic sources. An improvement in the ability to communicate is also ensured by this procedure.

The invention is described in greater detail in the following in an example by means of the associated drawing, which explains the inventive arrangement of the emergency calling device.

The invention is described in the following for the case of a motor vehicle. It is, however, equally relevant for other types of passenger transporting systems, such as trucks, small aircraft or the like, in which an emergency calling device may be installed. For the audio output, the telephone or the telematics 16 require only that the radio or radio navigation system 20 be muted. At the same time, communication between the telephone device 16 and the radio system 20 is ensured over a CAN bus. In the data block, the CAN message contains the information whether or not the telephone conversation is an emergency call. The reproduction parameters, which are to be set for an emergency call, either are stored in the radio system or transmitted by way of the CAN message.

A sensor 10, such as an acceleration sensor, indicates a critical driving situation or an accident. It is also conceivable that such a signal originates directly from an airbag control device. Moreover, the arrangement may also be a more complicated one, in which a sensor recognizes a critical driving situation and initiates an emergency call over the telematics, the call containing important information, such as the position of the vehicle, determined by way of the GPS, the number of occupants, etc. This is advantageous because, in the case of an actual accident, the emergency calling device may be destroyed, so that it is impossible to establish a telephone connection. Upon confirmation of an accident by a second sensor system, as in the case when the occupant of the vehicle has actuated an emergency calling key 12, the system recognizes an accident (14) and brings about the establishment of a phone connection between the telephone device 16 and the call center 18. Moreover, the connection between the sensor 10 and the telephone device 16 can be established over a CAN bus line.

The stereo terminal repeater 22 amplifies the signal, originating from the radio system 20, and passes it on to the speaker 24. Various embodiments are conceivable with respect to adjusting the minimum loudness. For example, a pre-definded value at three different positions can be set by actuating units, namely at the telephone device 16, at the radio system 20 or at the stereo terminal repeater 22. For safety reasons, the user cannot vary the minimum loudness set, the value of which may, of course, vary for different types of vehicles.

However, by adjusting the frequency responses of the reproduction only the low-frequency signals are to be amplified, as otherwise the noise in the leads between the various components would be amplified.

Aside from the minimum loudness, various other parameters of the audio reproduction are affected. The balance of the acoustic reproduction is centered and the fade control is set to the front, so that the sound reaches the vehicle occupants optimally. If the microphone, provided in the telephone device 16, is used for different system components, such as the telephone and speech recognition, it is necessary to make certain that the telephone assumes control of the microphone at the time that the emergency call is made.

### LIST OF REFERENCE SYMBOLS

10 acceleration sensor
12 emergency calling key
14 decision: accident recognized or emergency calling key actuated
16 telephone facility/telematics
18 call center
20 radio system/radio navigation system
22 stereo terminal repeater
24 speaker

1. Emergency calling system for a passenger transporting system, especially for a motor vehicle, which includes at least one transmitter for establishing a telephone connection with an external receiving station, such as a call center (18) or the like, at least one audio source and at least one speaker (24), characterized in that at least one reproduction parameter of the audio output is set to a predefined value after the telephone connection is established.

2. The emergency calling system of claim 1, characterized in that the emergency calling system includes a mobile telephone facility and a radio or radio navigation system (20).

3. Amended) The emergency calling system of claim 1, characterized in that the telephonic connection can be established in that an emergency calling key (12) or the like is activated by a person or by a sensor, which ascertains a critical situation or an accident, which has already taken place.

4. The emergency calling system of claim 1, characterized in that the loudness of the audio output is set to a minimum value after the telephonic connection has been established.

5. The emergency calling system of claim 4, characterized in that the loudness of the audio output can be increased, but not decreased manually with respect to the set minimum value.

6. The emergency calling system of claim 4, characterized in that it has means for calculating the minimum value, which is to be set as a function of the noise level.

7. The emergency calling system of claim 1, characterized in that the balance of the audio output is centered after the telephonic connection is established.

8. The emergency calling system of claim 1, characterized in that the fade control is set to the front after the telephonic connection has been established.

9. Method for automatically transmitting an emergency call from a passenger transporting system, especially from a motor vehicle, characterized in that at least one reproduction parameter of the audio output is set to a predefined value when the telephonic connection is established.

10. The method of claim 9, characterized in that the telephonic connection is established when an emergency calling key (12) or the like is activated by a person or by a sensor, who or which has ascertained a critical situation or an accident, which has already taken place.

11. The method of claim 9, characterized in that the loudness of the audio output is set to a minimum value.

12. The method of claim 11, characterized in that the loudness of the audio output can be increased but not decreased manually with respect to the minimum value set.

13. The method of claim 11, characterized in that the minimum value, which is to be set, is determined as a function of the noise level.

14. The method of claim 9, characterized in that the balance of the audio output is centered.

15. The method of claims 9, characterized and that the fade controller is set to the front.

16. Audio reproduction device for a passenger transporting system, especially for a motor vehicle, characterized by an emergency calling system of claim 1.
